(19) United States
(12) Patent Application Publication
(10) Pub. No.: US 2025/0245045 A1
(43) Pub. Date: Jul. 31, 2025

(54) METHOD OF ADJUSTING RESOURCE ALLOCATION AND RELATED DEVICE

(71) Applicants: Beijing Zitiao Networking Technology Co., Ltd., Beijing (CN); Lemon Inc., Grand Cayman (KY)

(72) Inventors: Qinxin WANG, Beijing (CN); Yuan FENG, Singapore (SG); Jiawei FENG, Beijing (CN); Hongwei KANG, Beijing (CN); Yuzhou WANG, Beijing (CN); Dongming LIU, Beijing (CN); Ruidong PAN, Beijing (CN)

(21) Appl. No.: 19/039,770

(22) Filed: Jan. 28, 2025

(30) Foreign Application Priority Data
Jan. 29, 2024 (CN) 202410122952.4

(51) Int. Cl. G06F 9/50

(52) U.S. Cl. CPC G06F 9/5005

(57) ABSTRACT

The disclosure provides a method of adjusting resource allocation, including: in response to a resource allocation data exception event, analyzing multi-dimensional parameters of resource allocation, to obtain a contribution degree of each parameter to the resource allocation data exception event; analyzing a parameter with the contribution degree greater than a predetermined threshold to obtain an analysis result of the resource allocation data exception event, and readjusting resource allocation based on the analysis result. Based on the foregoing method of adjusting resource allocation, the disclosure further provides an apparatus, an electronic device, a storage medium, and a program product for adjusting resource allocation.

### CROSS REFERENCE

The application claims priority to Chinese Patent Application No. 202410122952.4, filed on Jan. 29, 2024 and entitled “METHOD OF ADJUSTING RESOURCE ALLOCATION AND RELATED DEVICE”, the entirety of which is incorporated herein by reference.

### FIELD

The disclosure relates to the field of Internet resource adjustment technologies, and in particular, to a method of adjusting resource allocation and a related device.

### BACKGROUND

With the development of Internet technology, the resource allocation gradually goes from non-automation to automation to improve efficiency and effect in allocating links. The full-process automatic resource allocation can effectively save human resources and improve the allocation effect. For the full-process automation resource allocation, monitoring the data exception occurring in the automatic resource allocation process, timely warning, attribution, promoting adjustment of resource allocation strategy and improving timeliness of adjustment are important in full-process automatic resource allocation, and is also the key capability of the full-process automatic trend intelligent allocation.

However, in the prior art, currently, a series of operations such as monitoring data exception, timely warning, attribution, resource reallocation according to a result and the like in the automatic resource allocation process need to be non-automatic, cannot be completed independently from manual work, still depends on manual experience, and results have strong subjectivity and poor timeliness.

### SUMMARY

In view of this, an object of the disclosure is to provide a method of adjusting resource allocation and a related device, which can effectively monitor data exception occurring in the automatic resource allocation process, timely alarm, attribute, and promote adjustment of a resource allocation strategy, and improve timeliness of adjustment, and an overall process can be automatically completed, and has a low manual dependency, so that subjectivity of a result can be effectively avoided, and timeliness of resource allocation adjustment can be effectively improved.

According to some embodiments of the disclosure, the method of adjusting resource allocation may include: in response to a resource allocation data exception event, analyzing multi-dimensional parameters of resource allocation, to obtain a contribution degree of each parameter to the resource allocation data exception event; analyzing a parameter with the contribution degree greater than a predetermined threshold to obtain an analysis result of the resource allocation data exception event, and readjusting resource allocation based on the analysis result.

Based on the attribution method of the above application, an embodiment of the disclosure provides an apparatus for adjusting resource allocation, including:
an analysis module configured to, in response to a resource allocation data exception event, analyze multi-dimensional parameters of resource allocation, to obtain a contribution degree of each parameter to the resource allocation data exception event;
an allocation module configured to, analyze a parameter with the contribution degree greater than a predetermined threshold to obtain an analysis result of the resource allocation data exception event, and readjust resource allocation based on the analysis result.

In addition, an embodiment of the disclosure further provides an electronic device, including a memory, a processor, and a computer program stored in the memory and executable on the processor, wherein the processor, when executing the program, implements the foregoing method.

An embodiment of the disclosure further provides a non-transitory computer-readable storage medium storing computer instructions, wherein the computer instructions are configured to cause a computer to perform foregoing method.

An embodiment of the disclosure further provides a computer program product including computer program instructions that, when executed on a computer, cause a computer to perform the foregoing method.

The method of adjusting resource allocation and a related device include: in response to a resource allocation data exception event, analyzing multi-dimensional parameters of resource allocation, to obtain a contribution degree of each parameter to the resource allocation data exception event; analyzing a parameter with the contribution degree greater than a predetermined threshold to obtain an analysis result of the resource allocation data exception event, and readjusting resource allocation based on the analysis result. According to an embodiment of the disclosure, when the resource allocation is adjusted, the data exception event of the resource allocation can be monitored first, then the multi-dimensional parameters influencing the resource allocation are analyzed to obtain the parameter with the highest contribution degree to the resource allocation data exception event, then the parameter is further refined and analyzed to obtain a final analysis result, and then the adjustment of the resource allocation is realized by using the analysis result. It can be seen that, in the whole process of the disclosure, the monitoring of resource allocation exception, the analysis of multi-dimensional parameters, the calculation of contribution degree, the refinement and analysis of the parameters with the highest contribution degree and the provision of related adjustment strategies according to the analysis result can be separated from manual work to realize process automation, and the waiting for manual experience analysis is not needed. Therefore, it can be seen from the foregoing statement that the embodiments of the disclosure can effectively monitor data exception occurring in the automatic resource allocation process, timely alarm, attribute, and promote adjustment of a resource allocation strategy, and improve timeliness of adjustment, and an overall process can be automatically completed, and has a low manual dependency, so that subjectivity of a result can be effectively avoided, and timeliness of resource allocation adjustment can be effectively improved.

### BRIEF DESCRIPTION OF DRAWINGS

In order to more clearly illustrate the technical solutions in the disclosure or related technologies, the accompanying drawings, which need to be used in the description of the embodiments or related technologies, are briefly introduced below, and obviously, the drawings in the following description are merely embodiments of the disclosure, and for those of ordinary skill in the art, other drawings may be obtained according to these drawings without creative work.

FIG. 1 shows an implementation flow of the method of adjusting resource allocation according to some embodiments of the disclosure;

FIG. 2 shows a schematic diagram of box-plots according to some embodiments of the disclosure;

FIG. 3 shows a schematic diagram of the apparatus for adjusting resource allocation according to some embodiments of the disclosure;

FIG. 4 shows a schematic structural diagram of hardware of an electronic device according to an embodiment of the disclosure.

### DETAILED DESCRIPTION

To make the objects, technical solutions and advantages of the disclosure more apparent, the disclosure will be described in further detail below with reference to specific embodiments and the accompanying drawings.

It should be noted that, unless otherwise defined, technical terms or scientific terms used in the embodiments of the disclosure should be of ordinary meanings understood by those skilled in the art to which the disclosure belongs. The terms “first”, “second” and similar terms used in the embodiments of the disclosure do not represent any order, quantity, or importance, but are merely used to distinguish different components. A word such as “comprising” or “including” or the like means that an element or object appearing in front of the word encompasses elements or objects listed appearing behind the word and equivalents thereof, without excluding other elements or objects. Similar terms such as “connected to” or “connected with” are not limited to physical or mechanical connections, but may include electrical connections, whether direct or indirect. “Upper”, “lower”, “left”, “right” and the like are only used to represent relative position relationships, and when the absolute position of the object to be described changes, the relative position relationship may also change accordingly.

It may be understood that, before the technical solutions of the embodiments of the disclosure are used, the user may be notified of the type of the involved personal information, the usage scope, the usage scenario and the like in an appropriate manner, and the authorization of the user is obtained.

For example, in response to receiving an active request from a user, prompt information is sent to the user to explicitly prompt the user, and the operation requested to be performed will need to acquire and use the personal information of the user. Therefore, the user can autonomously select whether to provide personal information to software or hardware such as an electronic device, an application program, a server or a storage medium executing the operation of the technical solution of the disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the disclosure, and other manners of meeting related laws and regulations may also be applied to implementations of the disclosure.

As described above, with the development of Internet technology, the resource allocation gradually goes from non-automation to automation to improve efficiency and effect in allocating links. The full-process automatic resource allocation can effectively save human resources and improve the allocation effect. For the full-process automation resource allocation, monitoring the data exception occurring in the automatic resource allocation process, timely warning, attribution, promoting adjustment of resource allocation strategy and improving timeliness of adjustment are important in full-process automatic resource allocation, and is also the key capability of the full-process automatic trend intelligent allocation. However, in the prior art, currently, a series of operations such as monitoring data exception, timely warning, attribution, resource reallocation according to a result and the like in the automatic resource allocation process need to be non-automatic, cannot be completed independently from manual work, still depends on manual experience, and results have strong subjectivity and poor timeliness.

To this end, some embodiments of the disclosure provide a method of adjusting resource allocation, when the resource allocation is adjusted, the data exception event of the resource allocation can be monitored first, then the multi-dimensional parameters influencing the resource allocation are analyzed to obtain the parameter with the highest contribution degree to the resource allocation data exception event, then the parameter is further refined and analyzed to obtain a final analysis result, and then the adjustment of the resource allocation is realized by using the analysis result. It can be seen that, in the whole process of the disclosure, the monitoring of resource allocation exception, the analysis of multi-dimensional parameters, the calculation of contribution degree, the refinement and analysis of the parameters with the highest contribution degree and the provision of related adjustment strategies according to the analysis result can be separated from manual work to realize process automation, and the waiting for manual experience analysis is not needed. Therefore, the embodiment of the disclosure can effectively monitor data exception occurring in the automatic resource allocation process, timely alarm, attribute, and promote adjustment of a resource allocation strategy, and improve timeliness of adjustment, and an overall process can be automatically completed, and has a low manual dependency, so that subjectivity of a result can be effectively avoided, and timeliness of resource allocation adjustment can be effectively improved.

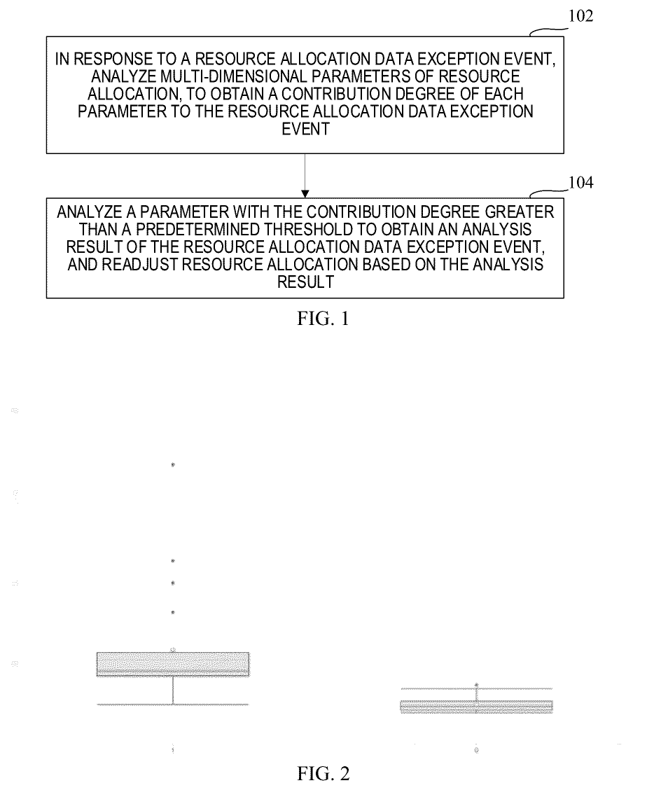

FIG. 1 shows an implementation flow of the method of adjusting resource allocation according to some embodiments of the disclosure. As shown in FIG. 1, the method can include the following steps.

In some embodiments of the disclosure, before in response to the resource allocation data exception event, analyzing multi-dimensional parameters of the resource allocation, to obtain the contribution degree of each parameter to the resource allocation data exception event, the method further includes: obtaining daily resource allocation data; determining whether an exception value exists in the daily resource allocation data by using a predetermined algorithm; and in response to the exception value existing in the daily resource allocation data, readjusting resource allocation.

In an embodiment of the disclosure, before the resource allocation data exception event is described, the daily resource allocation data needs to be first detected. The resource allocation data herein may include automatic resource allocation data, non-automatic resource allocation data, automatic resource allocation data at a first time, and automatic resource allocation data at a second time.

Firstly, resource allocation data of the current day needs to be obtained, and then determining whether an exception value exists in the daily resource allocation data by using a predetermined algorithm.

Specifically, the determination of the exception value may be determined by using a threshold, and if the threshold is higher than a threshold upper limit or lower than a threshold lower limit, it indicates that the data of the day is exception.

In some embodiments of the disclosure, the threshold lower limit is calculated by:

$${T}_{1} = {P}_{1} - 1.5 \times IQR$$

where T₁ represents the threshold lower limit, P₁ represents a 25% quantile, IQR represents a difference between P₃ and P₁, and P₃ represents a 75% quantile.

In some embodiments of the disclosure, the threshold upper limit is calculated by

$${T}_{2} = {P}_{3} + 1 \text{.5} \times IQR$$

where T₂ represents the threshold upper limit, IQR represents a difference between P₃ and P₁, P₃ represents a 75% quantile, and P₁ represents a 25% quantile.

After the threshold upper limit is calculated, the data of the current day can be determined. In the calculation process, the box plots method can also be adopted to visually determine the data.

FIG. 2 shows a schematic diagram of box-plots according to some embodiments of the disclosure.

As shown in FIG. 2, the box plot on the left is a box plot of automatic resource allocation data according to an embodiment of the disclosure, and the box plot on the right is a box plot of non-automatic resource allocation data according to an embodiment of the disclosure.

The middle line of the box, which is the median of the data, represents the average level of the sample data. The upper and lower limits of the box are the upper quartile and the lower quartile of the data, respectively. This means that the box contains 50% data. Therefore, the width of the box reflects the fluctuation degree of the data to some extent.

Above and below the box, there are another two lines, which represent the maximum and minimum values. The data point on the upper edge of the left box plot represents the exception data.

Obviously, in FIG. 2, there is exception data in the automatic resource allocation data, so it is necessary to locate the situation of the current day, analyze whether the error of resource allocation occurs in the current day, result in the occurrence of exception data, and if it is found that there is a corresponding error, correct the data, and if it is found that there is no error, continue to analyze the data by using the following steps.

In step 102, in response to a resource allocation data exception event, analyze multi-dimensional parameters of resource allocation, to obtain a contribution degree of each parameter to the resource allocation data exception event.

In the embodiments of the disclosure, mainly to solve the problem of resource allocation in two scenarios, one is that the first target parameter of the automatic resource allocation is higher than the first target parameter of the non-automatic resource allocation, and the other is the first target parameter of the automatic resource allocation at the first time is higher than the first target parameter of the automatic resource allocation at the second time. In the first scenario, the two resource allocation methods for automatic resource allocation and non-automatic resource allocation are coexisting, in this scenario, the disclosure needs to adjust the resource allocation, so that the first target parameter of the automatic resource allocation is lower than the first target parameter of the non-automatic resource allocation. When the first target parameter of the automatic resource allocation is higher than the first target parameter of the non-automatic resource allocation, it is determined that the resource allocation data exception event occurs. For the scenarios of automatic resource allocation and non-automatic resource allocation, the disclosure is expected to gradually transit to the scenario where only automatic resource allocation exists, and because it is essentially still expected to implement full-process automation. Therefore, in the transition process, it is necessary to optimize the effect of automatic resource allocation, so that the exception event is set to be the first target parameter of the automatic resource allocation higher than the first target parameter of the non-automatic resource allocation, so that the technical solution of automatic resource allocation can be continuously optimized, and when the data thereof gradually begins to stabilize, transition to the scenario where all automatic resource allocation exists can be considered. In the second scenario, which is a technical solution with only automatic resource allocation, it is still necessary to perform continuous optimization during the implementation process, so that the first target parameter of the automatic resource allocation is developed toward a lower value, and therefore in the second scenario, the exception event is set to be that the first target parameter of the automatic resource allocation at the first time is higher than the first target parameter of the automatic resource allocation at the second time, so that continuous optimization of the automatic resource allocation can be achieved.

In the following description, the disclosure describes a specific implementation process of the disclosure by using two branches.

First, a case in which the resource allocation data exception event is that the first target parameter of the automatic resource allocation is higher than the first target parameter of the non-automatic resource allocation is described.

In some embodiments of the disclosure, the resource allocation data exception event comprises: a first target parameter of automatic resource allocation is higher than a first target parameter of non-automatic resource allocation; in response to the resource allocation data exception event, analyzing multi-dimensional parameters of the resource allocation, to obtain the contribution degree of each parameter to the resource allocation data exception event comprises: in response to the first target parameter of automatic resource allocation being higher than the first target parameter of non-automatic resource allocation, analyzing a first difference between the multi-dimensional parameters of automatic resource allocation and the multi-dimensional parameters of non-automatic resource allocation; and analyzing and obtaining, based on the first difference, a contribution degree of each parameter to the first difference.

In embodiments of the disclosure, the multi-dimensional parameters refer to some parameters that may have an impact on resource allocation. In the prior art, when the resource allocation data exception event is detected, parameters of all dimensions are analyzed in detail, but a lot of manpower and material resources are consumed, and in the prior art, a manpower method is also adopted when the parameters are analyzed, which further affects the timeliness of obtaining an analysis result and adjusting resource allocation based on the analysis result. In the embodiments of the disclosure, the analysis of the contribution degree of the multi-dimensional parameters are performed first, so that the parameter that contributes most to the resource allocation data exception event of this time can be determined quickly, and then the parameter is subjected to targeted detailed analysis. Obviously, the source of the problem can be found quickly, and the effectiveness adjustment of the resource allocation can be realized as soon as possible.

In step 104, analyze a parameter with the contribution degree greater than a predetermined threshold to obtain an analysis result of the resource allocation data exception event, and readjusting resource allocation based on the analysis result.

In some embodiments of the disclosure, the multi-dimensional parameters comprise materials; analyzing a parameter with the contribution degree greater than the predetermined threshold to obtain the analysis result of the resource allocation data exception event, and readjusting resource allocation based on the analysis result comprises: in response to the parameters with the contribution degree greater than the predetermined threshold being the materials, determining whether the materials used by automatic resource allocation and the materials used by non-automatic resource allocation are the same; in response to the materials used by automatic resource allocation and the materials used by non-automatic resource allocation being different, analyzing features of the materials to obtain the analysis result; analyzing the materials used by non-automatic resource allocation to obtain available materials; and readjusting the allocation of the materials based on the analysis result and the available materials.

In an embodiment of the disclosure, in calculating the contribution degree, the contribution degree may be calculated by a weighted proportion method. Specifically, in the actual calculation process, the intra-class contribution degree and the inter-class contribution degree need to be calculated first, and then the sum of the intra-class contribution degree and the inter-class contribution degree is calculated, that is, the final comprehensive contribution degree is obtained.

In some embodiments of the disclosure, the intra-class contribution degree is calculated by:

$${C}_{1} = {w}_{i 2} ( {q}_{i 2} - {q}_{i 1} )$$

where C₁ represents the intra-class contribution degree, wᵢ₂ represents the denominator proportion of the current period dimension i, qᵢ₂ represents the index of the current period dimension i, and qᵢ₁ represents the index of the base period dimension i.

In an embodiment of the disclosure, when the parameter of the material is analyzed, a dimension i represents a material parameter dimension, the current period represents automatic resource allocation, the base period represents non-automatic resource allocation, and the denominator proportion of the current period dimension i represents the quantity of obtained second resources. The second resource is expressed in the embodiment of the disclosure to mean that after the resource is allocated, other resources can be obtained, and the second resource is included in the obtained other resources. The denominator proportion is used for the expression because in the embodiment of the disclosure, the first target parameter is division operation, and for the case that the target parameter is division operation, it is appropriate to use a weighted proportion method to calculate the contribution degree, where the denominator proportion refers to the parameter located in the denominator when the first target parameter is calculated, that is, the aforementioned second resource, and the denominator proportion refers to the ratio of the obtained second resource to the whole.

In some embodiments of the disclosure, the inter-class contribution value is calculated by:

$${C}_{2} = ( {q}_{i 1} - {Q}_{1} ) ( {w}_{i 2} - {w}_{i 1} )$$

where C₂ represents the inter-class contribution value, qᵢ₁ represents the index of the base period dimension i, Q₁ represents the overall index of base period, wᵢ₂ represents the denominator proportion of the current period dimension i, wᵢ₁ represents the denominator proportion of the base period dimension i.

In an embodiment of the disclosure, when the parameter of the material is analyzed, the overall index of base period represents a total value of a first target parameter of the non-automatic resource allocation, and the denominator proportion of the current period dimension i represents a quantity of second resources obtained in a case of automatic resource allocation. The remaining parameters are as shown above, and details are not described herein again.

Then, summing the intra-class contribution degree and the inter-class contribution degree to obtain the contribution degree of the dimension i, that is, the contribution degree corresponding to the parameter of the material.

In the foregoing step, a contribution degree corresponding to each material has been calculated, and the contribution degree reflects a contribution value of the material to the generated first difference.

Further, after the contribution degree corresponding to each parameter is calculated, a parameter corresponding to the contribution degree greater than the predetermined threshold is obtained.

In the embodiment of the present disclosure, it should be noted that, for convenience of description, only one parameter is taken, and in an actual application process, there may be a plurality of parameters whose corresponding contribution degrees are higher than the predetermined threshold, and then for each parameter whose contribution degree is higher than the predetermined threshold, a corresponding detailed analysis needs to be performed.

In an embodiment of the disclosure, taking the parameter as a material as an example, it needs to be determined whether the materials used by automatic resource allocation and the materials used by non-automatic resource allocation are the same, and if the materials used are not the same, the features of the materials need to be analyzed to obtain a corresponding analysis result, for example, whether the channel of the material sources has a problem is analyzed, and if a problem does occur, the channel of the material sources needs to be further adjusted accordingly, so that the repeatedly allocated materials can be adjusted, and thus the first target parameter can be optimized accordingly.

And then, analyzing the corresponding material classes of the automatic resource allocation, checking whether the corresponding influence of the material classes exists, and if the influence exists after the analysis, adjusting the selection of the material classes in the dimension.

Meanwhile, corresponding materials of non-automatic resource allocation can be analyzed simultaneously or in parallel, for example, the materials used by automatic resource allocation can be compared to check whether more excellent materials exist and are not selected by automatic resource allocation, if the materials exist, the corresponding materials are listed in a corresponding list, and in the subsequent adjustment process, whether the materials need to be added into a material library of automatic resource allocation is checked.

In an embodiment of the disclosure, when the channel of the material sources is adjusted, the contribution degree corresponding to each channel of material sources may also be continuously calculated. For example, the dimension corresponding the channel of the material sources may include a source recycled by using a predetermined model, a source recycled manually, and a source of repeated material allocation. In the foregoing steps, the contribution degrees corresponding to the three dimensions are calculated respectively, and assuming that the dimension of the source of the re-allocation of the material is taken as an example, that is, the contribution degree corresponding the dimension is higher than the predetermined threshold, the material in the dimension is further analyzed in detail. Specifically, it can be determined whether a problem occurs in the material during repeated allocation in the dimension of material re-allocation, and if a problem does occur, a channel of the material sources needs to be further adjusted accordingly, for example, an algorithm during repeated allocation of the material is adjusted, so that the repeatedly allocated material can be adjusted, and the first target parameter can be optimized accordingly.

In some embodiments of the disclosure, the method further includes: in response to the materials used by automatic resource allocation and the materials used by non-automatic resource allocation being the same, analyze creation parameters of the materials to obtain the analysis result; and readjust the allocation of the materials based on the analysis result.

In an embodiment of the disclosure, if materials used by automatic resource allocation and non-automatic resource allocation are the same, creation parameters corresponding to the materials are analyzed. For example, the creation times or the created days of the materials may be analyzed, and if there is a large difference in the creation times or the created days of the materials between automatic resource allocation and non-automatic resource allocation, the creation times or the created days of the materials used by automatic resource allocation are adjusted accordingly.

In addition, the creation times or the created days of the material corresponding to the lower first target parameter value in the non-automatic resource allocation may also be obtained, and used as a reference value to adjust the related parameters of the automatic resource allocation accordingly.

In some embodiments of the disclosure, the method further includes: in response to the materials used by automatic resource allocation and the materials used by non-automatic resource allocation being the same, determining whether objects allocated to the materials of automatic resource allocation and non-automatic resource allocation are the same; and in response to the objects allocated to the materials of automatic resource allocation and non-automatic resource allocation being different, adjusting the objects of automatic resource allocation.

In an embodiment of the disclosure, if the materials used by automatic resource allocation and non-automatic resource allocation are the same, but the objects allocated to the two are different, the objects allocated to the materials may be adjusted, and in an actual adjustment process, the objects corresponding to the automatic resource allocation in the dimension parameter may be modified, or the objects corresponding to the non-automatic resource allocation may be added to the objects corresponding to the automatic resource allocation.

In addition, whether there is a mismatch between the parameter and the allocated object corresponding to the parameter may be analyzed, and if the mismatch exists, the corresponding allocated object is appropriately adjusted as well.

In some embodiments of the disclosure, the multi-dimensional parameters comprise the objects of resource allocation; analyzing a parameter with the contribution degree greater than the predetermined threshold to obtain the analysis result of the resource allocation data exception event, and readjusting the resource allocation based on the analysis result comprises: in response to the parameters with the contribution degree greater than the predetermined threshold being the objects, analyzing the contribution degree of each object to the first difference; and in response to the contribution degree of the objects to the first difference being higher than the predetermined threshold, adjusting the objects.

In an embodiment of the disclosure, the parameters may also be objects of resource allocation, the objects has different classes, the contribution degrees of the objects of different classes to the first difference may be calculated, and when the contribution degree of a certain object is greater than a predetermined threshold, the objects of the dimension may be accordingly adjusted, and the adjustment method may refer to an adjustment method for the objects in the material, which is not described herein again. It should be noted that, although the adjustment of the objects is involved in both this and the foregoing methods of adjusting the material, objects actually adjusted by the two are not completely the same, because in the dimension corresponding to the material, the adjustment of the object is the premise that the dimension of the material exists and has the constraint condition, and the technical solution set forth herein directly analyzes different dimensions of the object, and there are some differences between the two.

In some embodiments of the disclosure, the multi-dimensional parameters comprise an allocation parameter, and the allocation parameter is a quantity of first resources allocated by the resource allocation; analyzing a parameter with the contribution degree greater than the predetermined threshold to obtain the analysis result of the resource allocation data exception event, and readjusting the resource allocation based on the analysis result comprises: in response to the parameters with the contribution degree greater than the predetermined threshold being the allocation parameter, readjusting the allocation parameter.

In the embodiments of the disclosure, when the resource is allocated, the first resource needs to be consumed, the first resource and the resource herein are two different resources, the allocation parameter mentioned here is an adjustment to the specific allocation of the first resource, the first resource is adjusted, the capability of the resource allocation itself is affected, and then the value of the final first target parameter is affected, so the first resource needs to be considered when considering the parameter. When the contribution degree of the allocation parameter is greater than the predetermined threshold, the relationship between the adjustment of the first resource and the change of the first target parameter is obtained respectively under the condition that the automatic resource allocation and the non-automatic resource allocation, and the related suggestion of the first resource adjustment is obtained through analysis based on the foregoing relationship.

When the resource allocation data exception event is the first target parameter of the automatic resource allocation at the first time being higher than the first target parameter of the automatic resource allocation at the second time, the specific implementation step is similar to the case in which the resource allocation data exception event is the first target parameter of the automatic resource allocation being higher than the first target parameter of the non-automatic resource allocation, and the automatic resource allocation is replaced with the automatic resource allocation at the first time, and the non-automatic resource allocation is replaced with the automatic resource allocation at the second time. Specifically, as shown below.

In step 102, in response to a resource allocation data exception event, analyze multi-dimensional parameters of resource allocation, to obtain a contribution degree of each parameter to the resource allocation data exception event.

In some embodiments of the disclosure, the resource allocation data exception event comprises: a first target parameter of automatic resource allocation at a first time is higher than a first target parameter of automatic resource allocation at a second time; in response to the resource allocation data exception event, analyzing multi-dimensional parameters of the resource allocation, to obtain the contribution degree of each parameter to the resource allocation data exception event comprises: in response to the first target parameter of automatic resource allocation at the first time being higher than the first target parameter of automatic resource allocation at the second time, analyzing a second difference between the first target parameter of automatic resource allocation at the first time and the first target parameter of automatic resource allocation at the second time; and analyzing and obtaining, based on the second difference, a contribution degree of each the parameter to the second difference.

In embodiments of the disclosure, the multi-dimensional parameters refer to some parameters that may have an impact on resource allocation. In the prior art, when the resource allocation data exception event is detected, parameters of all dimensions are analyzed in detail, but a lot of manpower and material resources are consumed, and in the prior art, a manpower method is also adopted when the parameters are analyzed, which further affects the timeliness of obtaining an analysis result and adjusting resource allocation based on the analysis result. In the embodiment of the disclosure, the analysis of the contribution degree of the multi-dimensional parameters are performed first, so that the parameter that contributes most to the resource allocation data exception event of this time can be determined quickly, and then the parameter is subjected to targeted detailed analysis. Obviously, the source of the problem can be found quickly, and the effectiveness adjustment of the resource allocation can be realized as soon as possible.

In step 104, analyze a parameter with the contribution degree greater than a predetermined threshold to obtain an analysis result of the resource allocation data exception event, and readjusting resource allocation based on the analysis result.

In some embodiments of the disclosure, the multi-dimensional parameters comprise materials; analyzing a parameter with the contribution degree greater than the predetermined threshold to obtain the analysis result of the resource allocation data exception event, and readjusting the resource allocation based on the analysis result comprises: in response to the parameters with the contribution degree greater than the predetermined threshold being the materials, determining whether the materials used by automatic resource allocation at the first time and the materials used by automatic resource allocation at the second time are the same; in response to the materials used by automatic resource allocation at the first time and the materials used by automatic resource allocation at the second time being different, analyzing features of the materials to obtain the analysis result; and/or analyzing the materials used by automatic resource allocation at the second time to obtain available materials; and readjusting the allocation of the materials based on the analysis result and/or the available materials.

In an embodiment of the disclosure, in calculating the contribution degree, the contribution degree may be calculated by a weighted proportion method. Specifically, in the actual calculation process, the intra-class contribution degree and the inter-class contribution degree need to be calculated first, and then the sum of the intra-class contribution degree and the inter-class contribution degree is calculated, that is, the final comprehensive contribution degree is obtained.

In some embodiments of the disclosure, the intra-class contribution degree is calculated by:

$${C}_{1} = {w}_{i 2} ( {q}_{i 2} - {q}_{i 1} )$$

where C₁ represents the intra-class contribution degree, wᵢ₂ represents the denominator proportion of the current period dimension i, qᵢ₂ represents the index of the current period dimension i, and qᵢ₁ represents the index of the base period dimension i.

In an embodiment of the disclosure, when the parameter of the material is analyzed, a dimension i represents a material parameter dimension, the current period represents automatic resource allocation at the first time, the base period represents automatic resource allocation at the second time, and the denominator proportion of the current period dimension i represents the quantity of obtained second resources. The second resource is expressed in the embodiment of the disclosure to mean that after the resource is allocated, other resources can be obtained, and the second resource is included in the obtained other resources. The denominator proportion is used for the expression because in the embodiment of the disclosure, the first target parameter is division operation, and for the case that the target parameter is division operation, it is appropriate to use a weighted proportion method to calculate the contribution degree, where the denominator proportion refers to the parameter located in the denominator when the first target parameter is calculated, that is, the aforementioned second resource, and the denominator proportion refers to the ratio of the obtained second resource to the whole.

In some embodiments of the disclosure, the inter-class contribution value is calculated by:

$${C}_{2} = ( {q}_{i 1} - {Q}_{1} ) ( {w}_{i 2} - {w}_{i 1} )$$

where C₂ represents the inter-class contribution value, qᵢ₁ represents the index of the base period dimension i, Q₁ represents the overall index of base period, wᵢ₂ represents the denominator proportion of the current period dimension i, wᵢ₁ represents the denominator proportion of the base period dimension i.

In an embodiment of the disclosure, when the parameter of the material is analyzed, the overall index of base period represents a total value of a first target parameter of the automatic resource allocation at the second time, and the denominator proportion of the current period dimension i represents a quantity of second resources obtained in a case of automatic resource allocation at the first time. The remaining parameters are as shown above, and details are not described herein again.

Then, summing the intra-class contribution degree and the inter-class contribution degree to obtain the contribution degree of the dimension i, that is, the contribution degree corresponding to the parameter of the material.

In the foregoing step, a contribution degree corresponding to each material has been calculated, and the contribution degree reflects a contribution value of the material to the generated first difference.

Further, after the contribution degree corresponding to each parameter is calculated, a parameter corresponding to the contribution degree greater than the predetermined threshold is obtained.

In the embodiment of the present disclosure, it should be noted that, for convenience of description, only one parameter is taken, and in an actual application process, there may be a plurality of parameters whose corresponding contribution degrees are higher than the predetermined threshold, and then for each parameter whose contribution degree is higher than the predetermined threshold, a corresponding detailed analysis needs to be performed.

In an embodiment of the disclosure, taking the parameter as a material as an example, it needs to be determined whether the materials used by automatic resource allocation at the first time and the materials used by automatic resource allocation at the second time are the same, and if the materials used are not the same, the features of the materials need to be analyzed to obtain a corresponding analysis result, for example, whether the channel of the material sources has a problem is analyzed, and if a problem does occur, the channel of the material sources needs to be further adjusted accordingly, so that the repeatedly allocated materials can be adjusted, and thus the first target parameter can be optimized accordingly.

And then, analyzing the corresponding material classes of the automatic resource allocation at the first time, checking whether the corresponding influence of the material classes exists, and if the influence exists after the analysis, adjusting the selection of the material classes in the dimension.

Meanwhile, corresponding materials of automatic resource allocation at the second time can be analyzed simultaneously or in parallel, for example, the materials used by automatic resource allocation at the first time can be compared to check whether more excellent materials exist and are not selected by automatic resource allocation, if the materials exist, the corresponding materials are listed in a corresponding list, and in the subsequent adjustment process, whether the materials need to be added into a material library of automatic resource allocation at the first time is checked.

In an embodiment of the disclosure, when the channel of the material sources is adjusted, the contribution degree corresponding to each channel of material sources may also be continuously calculated. For example, the dimension corresponding the channel of the material sources may include a source recycled by using a predetermined model, a source recycled manually, and a source of repeated material allocation. In the foregoing steps, the contribution degrees corresponding to the three dimensions are calculated respectively, and assuming that the dimension of the source of the re-allocation of the material is taken as an example, that is, the contribution degree corresponding the dimension is higher than the predetermined threshold, the material in the dimension is further analyzed in detail. Specifically, it can be determined whether a problem occurs in the material during repeated allocation in the dimension of material re-allocation, and if a problem does occur, a channel of the material sources needs to be further adjusted accordingly, for example, an algorithm during repeated allocation of the material is adjusted, so that the repeatedly allocated material can be adjusted, and the first target parameter can be optimized accordingly.

In some embodiments of the disclosure, the method further includes: in response to the materials used by automatic resource allocation at the first time and the materials used by automatic resource allocation at the second time being the same, analyzing creation parameters of the materials to obtain the analysis result; and readjusting the allocation of the materials based on the analysis result.

In an embodiment of the disclosure, if materials used by automatic resource allocation at the first time and the materials used by automatic resource allocation at the second time are the same, creation parameters corresponding to the materials are analyzed. For example, the creation times or the created days of the materials may be analyzed, and if there is a large difference in the creation times or the created days of the materials between automatic resource allocation and non-automatic resource allocation, the creation times or the created days of the materials used by automatic resource allocation are adjusted accordingly.

In addition, the creation times or the created days of the material corresponding to the lower first target parameter value in the automatic resource allocation at the second time may also be obtained, and used as a reference value to adjust the related parameters of the automatic resource allocation at the first time accordingly.

In some embodiments of the disclosure, the method further includes: in response to the materials used by automatic resource allocation at the first time and the materials used by automatic resource allocation at the second time being the same, determining whether objects allocated to the materials of automatic resource allocation at the first time and automatic resource allocation at the second time are the same; and in response to the objects of automatic resource allocation at the first time and the objects of automatic resource allocation at the second time being different, adjusting the objects of automatic resource allocation.

In an embodiment of the disclosure, if the materials used by automatic resource allocation at the first time and the materials used by automatic resource allocation at the second time are the same, but the objects allocated to the two are different, the objects allocated to the materials may be adjusted, and in an actual adjustment process, the objects corresponding to the automatic resource allocation at the first time in the dimension parameter may be modified, or the objects corresponding to the automatic resource allocation at the second time may be added to the objects corresponding to the automatic resource allocation at the first time.

In addition, whether there is a mismatch between the parameter and the allocated object corresponding to the parameter may be analyzed, and if the mismatch exists, the corresponding allocated object is appropriately adjusted as well.

In some embodiments of the disclosure, the multi-dimensional parameters comprise objects of the resource allocation; analyzing a parameter with the contribution degree greater than the predetermined threshold to obtain the analysis result of the resource allocation data exception event, and readjusting the resource allocation based on the analysis result comprises: in response to the parameters with the contribution degree greater than the predetermined threshold being the objects, analyzing the contribution degree of each object to the second difference; and in response to the contribution degree of the objects to the second difference being higher than the predetermined threshold, adjusting the objects.

In an embodiment of the disclosure, the parameters may also be objects of resource allocation, the objects has different classes, the contribution degrees of the objects of different classes to the first difference may be calculated, and when the contribution degree of a certain object is greater than a predetermined threshold, the objects of the dimension may be accordingly adjusted, and the adjustment method may refer to an adjustment method for the objects in the material, which is not described herein again. It should be noted that, although the adjustment of the objects is involved in both this and the foregoing methods of adjusting the material, objects actually adjusted by the two are not completely the same, because in the dimension corresponding to the material, the adjustment of the object is the premise that the dimension of the material exists and has the constraint condition, and the technical solution set forth herein directly analyzes different dimensions of the object, and there are some differences between the two.

In some embodiments of the disclosure, the multi-dimensional parameters comprise an allocation parameter, and the allocation parameter is a quantity of first resources allocated by the resource allocation; analyzing a parameter with the contribution degree greater than the predetermined threshold to obtain the analysis result of the resource allocation data exception event, and readjusting the resource allocation based on the analysis result comprises: in response to the parameters with the contribution degree greater than the predetermined threshold being the allocation parameter, adjusting the allocation parameter.

In the embodiments of the disclosure, when the resource is allocated, the first resource needs to be consumed, the first resource and the resource herein are two different resources, the allocation parameter mentioned here is an adjustment to the specific allocation of the first resource, the first resource is adjusted, the capability of the resource allocation itself is affected, and then the value of the final first target parameter is affected, so the first resource needs to be considered when considering the parameter. When the contribution degree of the allocation parameter is greater than the predetermined threshold, the relationship between the adjustment of the first resource and the change of the first target parameter is obtained respectively under the condition that the automatic resource allocation at the first time and the automatic resource allocation at the second time, and the related suggestion of the first resource adjustment is obtained through analysis based on the foregoing relationship.

In some embodiments of the disclosure, the method further includes: before in response to the resource allocation data exception event, analyzing multi-dimensional parameters of the resource allocation, to obtain the contribution degree of each parameter to the resource allocation data exception event, in response to the first target parameter of automatic resource allocation at the first time being higher than the first target parameter of automatic resource allocation at the second time, analyzing an influence of an external factor.

In an embodiment of the disclosure, for a case of the resource allocation data exception event in which the first target parameter of the automatic resource allocation at the first time is higher than the first target parameter of the automatic resource allocation at the second time, because there is a difference in time between the compared data, the impact caused by different time should be considered when considering the influence factor, because some special events may occur in some special time periods, of course, some special events may be directly prompted to occur, which is referred to as the external factor, and these external factors may cause the first target parameter to change, so the related influence of external factors also needs to be considered in this scenario. For example, if some external factors cause the overall first target parameter to be doubled at the second time compared to at the first time, and the first target parameter of automatic resource allocation at the second time is also doubled compared with the first target parameter of the automatic resource allocation at the first time, the present event may not be determined as the resource allocation data exception event, because the increasing amplitude is consistent, certainly, the decrease is also the same.

The method of adjusting resource allocation comprises the following steps: in response to a resource allocation data exception event, analyzing multi-dimensional parameters of resource allocation, to obtain a contribution degree of each parameter to the resource allocation data exception event; analyzing a parameter with the contribution degree greater than a predetermined threshold to obtain an analysis result of the resource allocation data exception event, and readjusting resource allocation based on the analysis result. According to an embodiment of the disclosure, when the resource allocation is adjusted, the data exception event of the resource allocation can be monitored first, then the multi-dimensional parameters influencing the resource allocation are analyzed to obtain the parameter with the highest contribution degree to the resource allocation data exception event, then the parameter is further refined and analyzed to obtain a final analysis result, and then the adjustment of the resource allocation is realized by using the analysis result. It can be seen that, in the whole process of the disclosure, the monitoring of resource allocation exception, the analysis of multi-dimensional parameters, the calculation of contribution degree, the refinement and analysis of the parameters with the highest contribution degree and the provision of related adjustment strategies according to the analysis result can be separated from manual work to realize process automation, and the waiting for manual experience analysis is not needed. Therefore, it can be seen from the foregoing statement that the embodiments of the disclosure can effectively monitor data exception occurring in the automatic resource allocation process, timely alarm, attribute, and promote adjustment of a resource allocation strategy, and improve timeliness of adjustment, and an overall process can be automatically completed, and has a low manual dependency, so that subjectivity of a result can be effectively avoided, and timeliness of resource allocation adjustment can be effectively improved.

It should be noted that the method in the embodiments of the disclosure may be performed by a single device, for example, a computer or a server. The method of the embodiment can also be applied to a distributed scene and is completed by the mutual cooperation of a plurality of devices. In this distributed scenario, one of the plurality of devices may perform only one or more steps in the method in the embodiments of the disclosure, and the plurality of devices interact with each other to complete the method.

It should be noted that some embodiments of the disclosure are described above. Other embodiments are within the scope of the appended claims. In some cases, the acts or steps recited in the claims may be performed in a different order than in the above embodiments and still achieve the desired results. Additionally, the processes depicted in the figures do not necessarily require a particular order or sequential order shown to achieve the desired results. In certain embodiments, multitasking and parallel processing are also possible or may be advantageous.

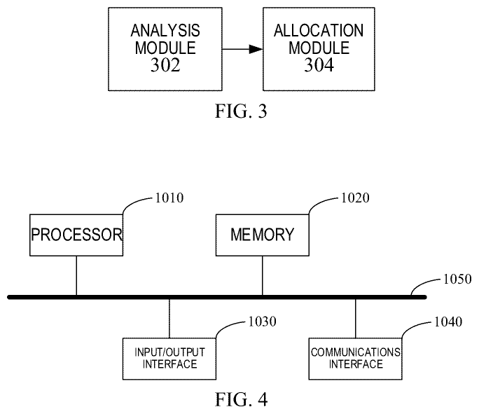

Corresponding to the above method of adjusting resource allocation, an embodiment of the disclosure further discloses an apparatus for adjusting resource allocation. FIG. 3 shows an internal structure of an apparatus for adjusting resource allocation according to an embodiment of the disclosure. As shown in FIG. 3, the apparatus may comprise:
an analysis module 302, configured to, in response to a resource allocation data exception event, analyze multi-dimensional parameters of resource allocation, to obtain a contribution degree of each parameter to the resource allocation data exception event; and
an allocation module 304, configured to, analyze a parameter with the contribution degree greater than a predetermined threshold to obtain an analysis result of the resource allocation data exception event, and readjust resource allocation based on the analysis result.

In some embodiments of the disclosure, the resource allocation data exception event comprises: a first target parameter of automatic resource allocation is higher than a first target parameter of non-automatic resource allocation;
the analysis module 302 comprises:
a first analysis unit configured to, in response to the first target parameter of automatic resource allocation being higher than the first target parameter of non-automatic resource allocation, analyze a first difference between the multi-dimensional parameters of automatic resource allocation and the multi-dimensional parameters of non-automatic resource allocation; and
a first contribution degree calculation unit, configured to analyze and obtain, based on the first difference, the contribution degree of each parameter to the first difference.

In some embodiments of the disclosure, the resource allocation data exception event comprises: a first target parameter of automatic resource allocation at a first time is higher than a first target parameter of automatic resource allocation at a second time;
the analysis module 302 comprises:
a second analysis unit configured to, in response to the first target parameter of automatic resource allocation at the first time being higher than the first target parameter of automatic resource allocation at the second time, analyze a second difference between the multi-dimensional parameters of automatic resource allocation at the first time and the multi-dimensional parameters of automatic resource allocation at the second time; and
a second contribution degree calculation unit, configured to analyze and obtain, based on the second difference, the contribution degree of each the parameter to the second difference.

In some embodiments of the disclosure, the apparatus further comprising:
an obtaining module, configured to obtain daily resource allocation data;
a first determining module, configured to determine whether an exception value exists in the daily resource allocation data by using a predetermined algorithm; and
an adjusting module configured to, in response to the exception value existing in the daily resource allocation data, readjust the resource allocation.

In some embodiments of the disclosure, the apparatus further comprising:
an external factor analysis module configured to, in response to the first target parameter of automatic resource allocation at the first time being higher than the first target parameter of automatic resource allocation at the second time, analyze an influence of an external factor.

In some embodiments of the disclosure, the multi-dimensional parameters comprise a material;
the allocation module 304 comprises:
a first determining unit configured to, in response to the corresponding parameter with the contribution degree greater than the predetermined threshold being the material, determine whether the material used by automatic resource allocation and the material used by non-automatic resource allocation are the same;
a third analysis unit configured to, in response to the materials used by automatic resource allocation and the material used by non-automatic resource allocation being different, analyze features of the material to obtain the analysis result; and/or analyze the material used by non-automatic resource allocation to obtain an available material; and
a first material adjusting unit, configured to readjust the allocation of the material based on the analysis result and/or the available material.

In some embodiments of the disclosure, the apparatus further comprising:
a first parameter analysis module configured to, in response to the material used by automatic resource allocation and the material used by non-automatic resource allocation being the same, analyze a creation parameter of the material to obtain the analysis result; and
a first material adjusting module configured to readjust the allocation of the materials based on the analysis result.

In some embodiments of the disclosure, the apparatus further comprising:
a second determining module configured to, in response that the material used by automatic resource allocation and the material used by non-automatic resource allocation being the same, determine whether objects allocated to the materials of automatic resource allocation and non-automatic resource allocation are the same; and
a first object adjusting module configured to, in response to the objects allocated to the materials of automatic resource allocation and non-automatic resource allocation being different, adjust the object of automatic resource allocation.

In some embodiments of the disclosure, the multi-dimensional parameters comprise objects of resource allocation;
the allocation module 304 comprises:
a first object contribution degree calculation unit configured to, in response to the parameter with the contribution degree greater than the predetermined threshold being the object, analyze the contribution degree of each object to the first difference; and
a first object adjusting unit configured to, in response to the contribution degree of the object to the first difference being higher than the predetermined threshold, adjust the object.

In some embodiments of the disclosure, the multi-dimensional parameters comprise an allocation parameter, and the allocation parameter is a quantity of first resources allocated by the resource allocation;
the allocation module 304 comprises:
a first allocation parameter adjusting unit configured to, in response to the parameter with the contribution degree greater than the predetermined threshold being the allocation parameter, readjust the allocation parameter.

In some embodiments of the disclosure, the multi-dimensional parameters comprise a material;
the allocation module 304 comprises:
a second determining unit configured to, in response to the parameter with the contribution degree greater than the predetermined threshold being the material, determine whether the material used by automatic resource allocation at the first time and the material used by automatic resource allocation at the second time are the same;
a fourth analysis unit configured to, in response to the material used by automatic resource allocation at the first time and the material used by automatic resource allocation at the second time being different, analyze features of the material to obtain the analysis result; and/or analyze the material used by automatic resource allocation at the second time to obtain an available material; and
a second material adjusting unit configured to readjust an allocation of the material based on the analysis result and the available material.

In some embodiments of the disclosure, the apparatus further comprising:
a second parameter analysis module configured to, in response to the material used by automatic resource allocation at the first time and the material used by automatic resource allocation at the second time being the same, analyze a creation parameter of the material to obtain the analysis result; and
a second material adjusting module configured to readjust the allocation of the material based on the analysis result.

In some embodiments of the disclosure, the apparatus further comprising:
a third determining module configured to, in response to the material used by automatic resource allocation at the first time and the material used by automatic resource allocation at the second time being the same, determine whether objects allocated to the materials of automatic resource allocation at the first time and automatic resource allocation at the second time are the same; and
a second object adjusting module configured to, in response to the object of the automatic resource allocation at the first time and the object of automatic resource allocation at the second time being different, adjust the object of automatic resource allocation.

In some embodiments of the disclosure, the multi-dimensional parameters comprise objects of resource allocation;
the allocation module 304 comprises:
a second object contribution degree calculation unit configured to, in response to the parameter with the contribution degree greater than the predetermined threshold being the object, analyze the contribution degree of each object to the second difference; and
a second object adjusting unit configured to, in response to the contribution degree of the object to the second difference being higher than the predetermined threshold, adjust the object.

In some embodiments of the disclosure, the multi-dimensional parameters comprise an allocation parameter, and the allocation parameter is a quantity of first resources allocated by the resource allocation;
the allocation module 304 comprises:
a second allocation parameter adjusting unit configured to, in response to the parameter with the contribution degree greater than the predetermined threshold being the allocation parameter, adjust the allocation parameter.

For convenience of description, the above apparatus are described as being divided into various modules by functions, when the above apparatus is described. Of course, the functions of the modules may be implemented in one or more software and/or hardware when implementing the disclosure.

The apparatus of the foregoing embodiment is configured to implement the corresponding method of adjusting resource allocation in any of the foregoing embodiments, and has the beneficial effects of the corresponding method embodiments, and details are not described herein again.

Based on the same inventive concept, corresponding to the method of any of embodiments described above, the disclosure further provides an electronic device, comprising a memory, a processor, and a computer program stored in the memory and executable on the processor, wherein the processor, when executing the program, implements the method of adjusting resource allocation according to any of the above embodiments.

FIG. 4 is a schematic structural diagram of a more specific hardware structure of an electronic device according to this embodiment, and the device may include a processor 1010, a memory 1020, an input/output interface 1030, a communications interface 1040, and a bus 1050. The processor 1010, the memory 1020, the input/output interface 1030, and the communications interface 1040 implement, by using the bus 1050, a communication connection with each other inside the device.

The processor 1010 may be implemented in a form of a general-purpose central processing unit (CPU), a microprocessor, an application specific integrated circuit (ASIC), or one or more integrated circuits, and is configured to execute related programs to implement the technical solutions provided in the embodiments of the specification.

The memory 1020 may be implemented in a form of a ROM (Read Only Memory), a Random Access Memory (RAM), a static storage device, a dynamic storage device, or the like. The memory 1020 may store an operating system and other applications, and when implementing the technical solutions provided in the embodiments of the specification by using software or firmware, related program code is stored in the memory 1020 and invoked and executed by the processor 1010.

The input/output interface 1030 is configured to connect the input/output module to implement information input and output. The input/output module may be configured as a component in the device (not shown in the figure), or may be externally connected to the device to provide a corresponding function. The input device may include a keyboard, a mouse, a touch screen, a microphone, various sensors, etc., and the output device may include a display, a speaker, a vibrator, an indicator light, and the like.

The communications interface 1040 is configured to connect a communications module (not shown in the figure), to implement communications interaction between the device and another device. The communications module may implement communications in a wired manner (for example, a USB or a network cable), or may implement communications in a wireless manner (for example, a mobile network, a Wi-Fi, a Bluetooth, and the like).

The bus 1050 includes a path to transfer information between various components of the device, such as the processor 1010, the memory 1020, the input/output interface 1030, and the communication interface 1040.

It should be noted that although the foregoing device only shows the processor 1010, the memory 1020, the input/output interface 1030, the communications interface 1040, and the bus 1050, in a specific implementation process, the device may further include other components necessary to implement normal running. In addition, those skilled in the art may understand that the foregoing device may also include only components necessary for implementing the solutions in the embodiments of the specification, and does not necessarily include all components shown in the figure.

The electronic device of the foregoing embodiment is configured to implement the corresponding method of adjusting resource allocation in any of the foregoing embodiments, and has the beneficial effects of the corresponding method embodiments, and details are not described herein again.

Based on the same inventive concept, corresponding to the method of any of embodiments described above, the disclosure further provides a non-transitory computer-readable storage medium storing computer instructions, wherein the computer instructions are configured to cause a computer to perform the method of adjusting resource allocation according to any of the above embodiments.

The computer-readable media of the embodiment of the disclosure include permanent and non-permanent, removable and non-removable media that may be implemented by any method or technology for storing information. The information may be computer readable instructions, data structures, modules of a program, or other data. Examples of computer storage media include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disc read-only memory (CD-ROM), digital versatile disc (DVD) or other optical storage, magnetic cassettes, magnetic tape magnetic disk storage or other magnetic storage devices, or any other non-transmission medium, which can be used to store information that can be accessed by a computing device.

The computer instructions stored in the storage medium in the foregoing embodiments are configured to cause the computer to perform the method of adjusting resource allocation according to any of the foregoing embodiments, and have the beneficial effects of the corresponding method embodiments, and details are not described herein again.

Based on the same inventive concept, corresponding to the method of adjusting resource allocation of any of embodiments described above, the disclosure further provides a computer program product, comprising a computer program instruction. In some embodiments, the computer program instructions may be executed by one or more processors of a computer to cause the computer and/or the processor to perform the method of adjusting resource allocation. Corresponding to the execution body corresponding to each step in the embodiments of the method of adjusting resource allocation, the processor executing the corresponding step may belong to the corresponding executing body.

The computer program product of the foregoing embodiment is configured to cause the computer and/or the processor to perform the method of adjusting resource allocation according to any of the foregoing embodiments, and has the beneficial effects of the corresponding method embodiments, and details are not described herein again.

It should be understood by those of ordinary skill in the art that the discussion of any of the above embodiments is merely exemplary and is not intended to suggest that the scope of the disclosure, including the claims, is limited to these examples; in the spirit of the disclosure, the above embodiments or the technical features in different embodiments may also be combined, the steps may be implemented in any order, and there are many other variations of the different aspects of the embodiments of the disclosure as described above, which are not provided in detail for the sake of brevity.

Additionally, for simplicity of illustration and discussion, and to not obscure embodiments of the disclosure, well-known power/ground connections to integrated circuit (IC) chips and other components may or may not be shown in the figures provided. Moreover, the apparatus may be shown in block diagram form in order to avoid obscuring the embodiments of the disclosure, and this also takes into account the fact that the details regarding the implementation of these block diagram apparatus are highly dependent on the platform in which the embodiments of the disclosure are to be implemented (i.e., these details should be fully within the understanding of those skilled in the art). Having set forth specific details (e.g., circuits) to describe exemplary embodiments of the disclosure, it will be apparent to those skilled in the art that embodiments of the disclosure may be practiced without these specific details or with changes to these specific details. Accordingly, these descriptions should be considered illustrative and not limiting.

Although the disclosure has been described in conjunction with specific embodiments of the disclosure, many alternatives, modifications, and variations of these embodiments will be apparent to those of ordinary skill in the art from the foregoing description. For example, other memory architectures (e.g., dynamic RAM (DRAM)) may use the embodiments discussed.

The embodiments of the disclosure is intended to cover all such alternatives, modifications and variations that fall within the broad scope of the appended claims. Therefore, any omission, modification, equivalent replacement, improvement and the like that are made within the spirit and principle of the embodiments of the disclosure should be included within the protection scope of the disclosure.

I/We claim:

1. A method of adjusting resource allocation, comprising:
in response to a resource allocation data exception event, analyzing multi-dimensional parameters of resource allocation, to obtain a contribution degree of each parameter to the resource allocation data exception event; and
analyzing a parameter with the contribution degree greater than a predetermined threshold to obtain an analysis result of the resource allocation data exception event, and readjusting the resource allocation based on the analysis result.

2. The method of claim 1, wherein the resource allocation data exception event comprises: a first target parameter of automatic resource allocation is higher than a first target parameter of non-automatic resource allocation;
wherein in response to the resource allocation data exception event, analyzing the multi-dimensional parameters of the resource allocation, to obtain the contribution degree of each parameter to the resource allocation data exception event comprises:
in response to the first target parameter of automatic resource allocation being higher than the first target parameter of non-automatic resource allocation, analyzing a first difference between the first target parameter of automatic resource allocation and the first target parameter of non-automatic resource allocation; and
analyzing and obtaining, based on the first difference, the contribution degree of each parameter to the first difference.

3. The method of claim 1, wherein the resource allocation data exception event comprises: a first target parameter of automatic resource allocation at a first time is higher than a first target parameter of automatic resource allocation at a second time;
wherein in response to the resource allocation data exception event, analyzing the multi-dimensional parameters of the resource allocation, to obtain the contribution degree of each parameter to the resource allocation data exception event comprises:
in response to the first target parameter of automatic resource allocation at the first time being higher than the first target parameter of automatic resource allocation at the second time, analyzing a second difference between the first target parameter of automatic resource allocation at the first time and the first target parameter of automatic resource allocation at the second time; and
analyzing and obtaining, based on the second difference, the contribution degree of each the parameter to the second difference.

4. The method of claim 1, further comprising: before in response to the resource allocation data exception event, analyzing the multi-dimensional parameters of the resource allocation, to obtain the contribution degree of each parameter to the resource allocation data exception event,
obtaining daily resource allocation data;
determining whether an exception value exists in the daily resource allocation data by using a predetermined algorithm; and
in response to the exception value existing in the daily resource allocation data, readjusting the resource allocation.

5. The method of claim 3, further comprising: before in response to the resource allocation data exception event, analyzing the multi-dimensional parameters of the resource allocation, to obtain the contribution degree of each parameter to the resource allocation data exception event,
in response to the first target parameter of automatic resource allocation at the first time being higher than the first target parameter of automatic resource allocation at the second time, analyzing an influence of an external factor.

6. The method of claim 2, wherein the multi-dimensional parameters comprise a material;
wherein analyzing the parameter with the contribution degree greater than the predetermined threshold to obtain the analysis result of the resource allocation data exception event, and readjusting the resource allocation based on the analysis result comprises:
in response to the parameter with the contribution degree greater than the predetermined threshold being material, determining whether a material used by automatic resource allocation and a material used by non-automatic resource allocation are a same material;
in response to the material used by automatic resource allocation and the material used by non-automatic resource allocation being different, analyzing features of the material to obtain the analysis result;
and/or analyzing the material used by non-automatic resource allocation to obtain an available material; and
readjusting an allocation of the material based on the analysis result and/or the available material.

7. The method of claim 6, further comprising:
in response to the material used by automatic resource allocation and the material used by non-automatic resource allocation being the same material, analyzing a creation parameter of the material to obtain the analysis result; and
readjusting the allocation of the material based on the analysis result.

8. The method of claim 6, further comprising:
in response to the material used by automatic resource allocation and the material used by non-automatic resource allocation being the same material, determining whether an object allocated to the material of automatic resource allocation and an object allocated to the material of non-automatic resource allocation are a same object; and
in response to the object allocated to the material of automatic resource allocation and the object allocated to the material of non-automatic resource allocation being different, adjusting the object of automatic resource allocation.

9. The method of claim 2, wherein the multi-dimensional parameters comprise an object of resource allocation;
wherein analyzing the parameter with the contribution degree greater than the predetermined threshold to obtain the analysis result of the resource allocation data exception event, and readjusting the resource allocation based on the analysis result comprises:
in response to the parameter with the contribution degree greater than the predetermined threshold being the object, analyzing the contribution degree of each object to the first difference; and
in response to the contribution degree of the object to the first difference being higher than the predetermined threshold, adjusting the object.

10. The method of claim 2, wherein the multi-dimensional parameters comprise an allocation parameter, and the allocation parameter is a quantity of first resources allocated by the resource allocation;
wherein analyzing the parameter with the contribution degree greater than the predetermined threshold to obtain the analysis result of the resource allocation data exception event, and readjusting the resource allocation based on the analysis result comprises:
in response to the parameter with the contribution degree greater than the predetermined threshold being the allocation parameter, readjusting the allocation parameter.

11. The method of claim 3, wherein the multi-dimensional parameters comprise a material;
wherein analyzing the parameter with the contribution degree greater than the predetermined threshold to obtain the analysis result of the resource allocation data exception event, and readjusting the resource allocation based on the analysis result comprises:
in response to the parameter with the contribution degree greater than the predetermined threshold being the material, determining whether the material used by automatic resource allocation at the first time and the material used by automatic resource allocation at the second time are a same material;
in response to the material used by automatic resource allocation at the first time and the material used by automatic resource allocation at the second time being different, analyzing features of the material to obtain the analysis result; and/or analyzing the material used by automatic resource allocation at the second time to obtain an available material; and
readjusting an allocation of the material based on the analysis result and/or the available material.

12. The method of claim 11, further comprising:
in response to the material used by automatic resource allocation at the first time and the material used by automatic resource allocation at the second time being the same material, analyzing a creation parameter of the material to obtain the analysis result; and
readjusting the allocation of the material based on the analysis result.

13. The method of claim 11, further comprising:
in response to the material used by automatic resource allocation at the first time and the material used by automatic resource allocation at the second time being the same material, determining whether an object allocated to the material of automatic resource allocation at the first time and an object allocated to the material of automatic resource allocation at the second time are a same object; and
in response to the object of automatic resource allocation at the first time and the object of automatic resource allocation at the second time being different, adjusting the object of automatic resource allocation.

14. The method of claim 3, wherein the multi-dimensional parameters comprise an object of the resource allocation;
wherein analyzing the parameter with the contribution degree greater than the predetermined threshold to obtain the analysis result of the resource allocation data exception event, and readjusting the resource allocation based on the analysis result comprises:
in response to the parameter with the contribution degree greater than the predetermined threshold being the object, analyzing the contribution degree of each object to the second difference; and
in response to the contribution degree of the object to the second difference being higher than the predetermined threshold, adjusting the object.

15. The method of claim 3, wherein the multi-dimensional parameters comprise an allocation parameter, and the allocation parameter is a quantity of first resources allocated by the resource allocation;
wherein analyzing the parameter with the contribution degree greater than the predetermined threshold to obtain the analysis result of the resource allocation data exception event, and readjusting the resource allocation based on the analysis result comprises:
in response to the parameter with the contribution degree greater than the predetermined threshold being the allocation parameter, adjusting the allocation parameter.

16. An electronic device, comprising a memory, a processor, and a computer program stored in the memory and executable on the processor, wherein the processor, when executing the program, implements acts comprising:
in response to a resource allocation data exception event, analyzing multi-dimensional parameters of resource allocation, to obtain a contribution degree of each parameter to the resource allocation data exception event; and
analyzing a parameter with the contribution degree greater than a predetermined threshold to obtain an analysis result of the resource allocation data exception event, and readjusting resource allocation based on the analysis result.

17. The electronic device of claim 16, wherein the resource allocation data exception event comprises: a first target parameter of automatic resource allocation is higher than a first target parameter of non-automatic resource allocation;
wherein in response to the resource allocation data exception event, analyzing the multi-dimensional parameters of the resource allocation, to obtain the contribution degree of each parameter to the resource allocation data exception event comprises:
in response to the first target parameter of automatic resource allocation being higher than the first target parameter of non-automatic resource allocation, analyzing a first difference between the first target parameter of automatic resource allocation and the first target parameter of non-automatic resource allocation; and
analyzing and obtaining, based on the first difference, the contribution degree of each parameter to the first difference.

18. The electronic device of claim 16, wherein the resource allocation data exception event comprises: a first target parameter of automatic resource allocation at a first time is higher than a first target parameter of automatic resource allocation at a second time;
wherein in response to the resource allocation data exception event, analyzing the multi-dimensional parameters of the resource allocation, to obtain the contribution degree of each parameter to the resource allocation data exception event comprises:
in response to the first target parameter of automatic resource allocation at the first time being higher than the first target parameter of automatic resource allocation at the second time, analyzing a second difference between the first target parameter of automatic resource allocation at the first time and the first target parameter of automatic resource allocation at the second time; and
analyzing and obtaining, based on the second difference, the contribution degree of each the parameter to the second difference.

19. The electronic device of claim 16, the acts further comprise: before in response to the resource allocation data exception event, analyzing the multi-dimensional parameters of the resource allocation, to obtain the contribution degree of each parameter to the resource allocation data exception event,
obtaining daily resource allocation data;
determining whether an exception value exists in the daily resource allocation data by using a predetermined algorithm; and
in response to the exception value existing in the daily resource allocation data, readjusting resource allocation.

20. A non-transitory computer-readable storage medium storing computer instructions, wherein the computer instructions are configured to cause a computer to perform acts comprising:
in response to a resource allocation data exception event, analyzing multi-dimensional parameters of resource allocation, to obtain a contribution degree of each parameter to the resource allocation data exception event; and
analyzing a parameter with the contribution degree greater than a predetermined threshold to obtain an analysis result of the resource allocation data exception event, and readjusting resource allocation based on the analysis result.
